(19) United States
(12) Patent Application Publication
(10) Pub. No.: US 2010/0100464 A1
(43) Pub. Date: Apr. 22, 2010

(54) A MULTI-TASKED HUMAN RESOURCES AND PAYROLL ACCOUNTING SYSTEM

(75) Inventors: Ron Ellis, Clearwater, FL (US); George R. Gage, Clearwater, FL (US); Tom Signor, Clearwater, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: ESTAR INC., Clearwaterfl (FL)

(21) Appl. No.: 12/444,983

(22) PCT Filed: Oct. 10, 2007
(86) PCT No.: PCT/US07/80950

§ 371 Date: Apr. 9, 2009

Related U.S. Application Data
(60) Provisional application No. 60/828,938, filed on Oct. 10, 2006.

(51) Int. Cl. G06Q 10/00; G06Q 20/00; G08B 1/08; G06Q 30/00; G06F 17/30; H04L 9/32

(52) U.S. Cl. 705/33; 705/301; 705/39; 705/321; 340/539.13; 707/769; 726/5; 707/E17.014

(57) ABSTRACT

A human resources and payroll system having a plurality of separate modules includes a SQL server or alternative server being able to implement a back end database. In one example, each separate module is designed to be integrated seamlessly into the core payroll system. In another example, each separate module is capable of being controlled by a security management system. In one example, each separate module may be activated or deactivated by the security management system based on the needs or contracted arrangements of a client using the system.

### RELATED APPLICATION

This application is a National Stage of PCT/US2007/080950 filed on Oct. 10, 2007 which claims the benefit of the filing date of U.S. Provisional Patent Application No. 60/828,938 filed Oct. 10, 2006, the disclosure of which is hereby incorporated herein by reference.

### FIELD OF THE INVENTION

The field relates to human resources and payroll accounting systems.

### BACKGROUND OF THE INVENTION

Current human resources and payroll accounting systems often do not have the ability to perform complex human resources tasks. For example, many web-based time clocks only offer employees the capability of having employees login to clock-in and clock-out throughout the day. More complex time and attendance needs are not met by many current web time clocks.

There needs to be a system capable of performing complex human resources and payroll tasks.

### SUMMARY OF THE INVENTION

A human resources and payroll system capable of performing complex human resources and accounting tasks has a SQL® server or an alternative server being able to implement a back end database and a plurality of modules.¹ In one example, each module is designed to be integrated seamlessly into the core payroll system. ¹SQL® is a registered trademark of Microsoft Corporation.

In another example, each module is capable of being controlled by a security management system. In one example, each module may be activated or deactivated by the security management system based on the needs or contracted arrangements of a client using the system.

In one example, one of the modules may be used to manage multiple and complex time and attendance tasks and is a time clock module. In one example, data is collected and after review by assigned personnel, is pushed directly to a core human resources and payroll system. This may optimize employees' time and attendance functions by reducing double-keying, minimizing errors and enhancing efficiencies within the payroll department. In one example, the multiple time and attendance tasks include tracking work across multiple shifts, identifying tardy workers, assisting enforcement of daily and weekly work schedules, interactive scheduling of requests for vacation, personal days and/or sick days, and seamlessly integrating time tracking hardware, such as hardware incorporating RFID within company badges that allow tracking of employee location to determine the percentage of time spent at a desk, copier, file room or other location within or outside of the office.

In another example of a module for the system, an ad-hoc report writer module is provided as a portion of the payroll system, which integrates with the other features, providing advantages in time efficiency for administrators and supervisors.

In another example of a module for the system, a module allows end user to invoice their customers or clients using an automated billing process. For example, RFID tags in files can automatically bring up a time entry screen for entering time or starting a time clock for work on a particular file. The co-location of the file and the employee ID badge near a computer or other time entry device, such as a copy machine or other machine, allows the employee to easily select the client or customers account associated with the file for billing. In one example, any file in the office with an employee is correlated on the employee's display terminal with a switchable time clock, allowing the employee to start and stop the time clock for each of the customers or files physically located in the employee's office. The location of the file may be entered manually. In one example, a wireless device, such as RFID, is used to determine and login the file.

In another example of module for the system, an invoicing module automatically generates invoices for back office services to be rendered, schedules payments due and makes these invoices readily available to the client to preview or print as a hard copy while clients of a payroll service complete their payrolls, print paychecks and deposit advances at their own locations.

The system has the capability of having many human resources and payroll accounting modules. A few of the advantages of the separate modules are now described.

One advantage of the system is that it may include a report writer module which allows end-users to securely, easily and quickly select employee information and assemble queries without technical expertise with the queries being readily exportable to a third party software, such as a word processor, an e-mail program, or a presentation program for editing, formatting or distribution and for high quality presentation.

One advantage of a system having a time clock module is that the double keying is reduced and errors minimized, preventing missing data that is not timely released, enhancing efficiencies within the payroll department. Another advantage of such a module is that reporting is timely and allows for tracking of current and historical logs created by employee punches, audit logs of changes to employee records performed by supervisors, current payroll period status by day, by employee, showing punches, total hours, missing punches, early/late punches, attendance status, and other metrics on a real time basis or a near real time basis, allowing a system to notify supervisors of corrective actions to be taken.

An advantage of a system with a payroll module is that clients may choose to have their payroll provider complete the payroll processing and may allow the payroll service provider to launch the generation of batches of client invoices with a few simple mouse clicks. Yet another advantage of a system with a payroll module is that sales agents may securely track their sales commissions payables and sales commissions already paid.

These advantages are some of the advantages of such a system but are not limited to those recited.

### BRIEF DESCRIPTION OF THE DRAWING

The drawings describes one example of a human resources and payroll accounting system.

FIG. 1 illustrates one example of the system.

### DETAILED DESCRIPTION OF PREFERRED EMBODIMENTS OF THE INVENTION

The examples described and the drawings rendered are illustrative and are not to be read as limiting the scope of the invention as it is defined by the appended claims.

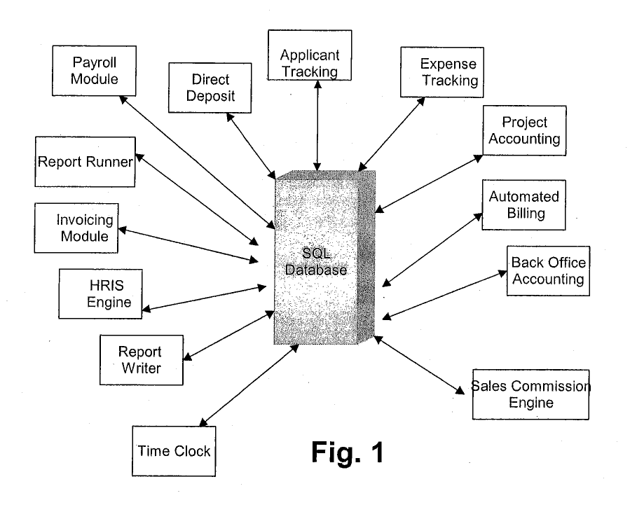

In an example illustrated in FIG. 1, a SQL® database is depicted with many human resources and payroll accounting modules such as invoicing module, automated billing module, report writer module, payroll module, back office accounting module, human resources information system engine module, applicant tracking module, expense tracking module, project accounting module, report runner module, time clock module and sales commission engine module.² ²SQL® is a registered trademark of Microsoft Corporation.

In one example, a human resources and payroll system is designed to meet the performance requirements of companies of all sizes, payroll service agencies, staffing services, professional employer organizations or PEO's, banks, and accounting firms in all 50 states. The self service capabilities of the system make it a simple process to bring on new users without requiring special hardware, thus providing the framework to easily link together companies, employees, and divisions quickly and efficiently.

In one example, a suite of modules and products include payroll, back office accounting, ACH Direct Deposit and Direct Debit batching, Human Resource Information System (HRIS), applicant tracking, expense tracking, project accounting, report runner, web time clock, and report publisher.

The human resources and payroll accounting system is flexibly designed for companies of all sizes, PEOs, ASOs, service bureaus, staffing organizations and HR Consulting Firms, and one example, is a 100% Web-based system with completely integrated modules.

The modules may be integrated on one code base, which can be utilized anytime, anywhere with just a browser connection to the Internet. For example, Microsoft Internet Information Server and Microsoft SQL® Server 2000 is used to provide the SQL® engine.³ ³SQL® is a registered trademark of Microsoft Corporation.

In one example, a payroll module is included in a system. Sometimes two or three sales agents will split various invoice line item fees, and the percentage splits can vary from invoice line item to invoice line item, all for the same client invoice. Sometimes the percentage splits can vary from client to client. Sometimes the sales commission percentages vary as the volume of business grows over the course of the calendar quarter or the calendar year. A system having a payroll module, automates this process, by allowing entry of sales commission fee splits, processing and reporting. The system allows multiple sales agents to share in the sales commissions due from a single client. Another advantage is that sales agents may securely track their sales commissions payables and sales commission already paid.

A system with a payroll module may also provide for high volumes of payroll processing and delivery throughout the day. Yet another advantage of a payroll system may be allowing a mix of clients to process their own payrolls while others are processed by a centralized payroll service provider or distributed payroll service providers located worldwide. Another advantage of a payroll system is the tracking of who is doing what and when dynamically and preventing conflicts between clients, their employees and customers having access to real time or near real time information and reporting. In one example, online reporting tools are capable of tracking work scheduled, work-in-process and work completed by payroll coordinator. In another example, online reporting tools allow for matching accounts payable to invoices generated on a client-by-client basis and forecasting a payroll service provider's credit exposure day by day- to help identify and prevent cash flow bottlenecks. In one example, the forecasting is predictive, using historical information and trends to predict cash flow problems before they happen, when corrective measures may be taken to accelerate collections on accounts receivables.

In yet another example, a client invoicing module allows automatic generation of invoices for the back office services to be rendered, scheduling of payments due and allow the invoices to be readily available to clients to preview or print as a hard copy as clients complete payrolls, print paychecks and deposit advances at their own locations. In another example, the client invoicing module may additionally allow the payroll service provider to launch a generation of batches of client invoices with a few simple mouse clicks if clients choose to have their payroll provider complete payroll processing.

In one example, the system includes a web-based human resource module. The web-based human resource module is capable of tracking the entire life cycle of employees from recruitment to retirement. It includes all data entry and corresponding reports for personnel tracking, applicant tracking, recruiting, labor relations, benefits administration, compensation, education and skills tracking. It includes ISO tracking capability, health and safety, time and attendance tracking, employee self-service, supervisor self-service, travel and expense reporting. It maintains employee handbook, EEO, AA, COBRA, OSHA, ADA, 1-9 and FMLA reporting requirements. It provides audit trails to view all changes and check data accuracy, and has powerful reporting capabilities that are easy to use with over numerous standard reports. The number may be over 200, for example.

In another example, the system includes a web-based payroll module. The web-based payroll module is designed to meet the complex payroll requirements for companies of all sizes and payroll & workforce management service bureaus. In this example, the system includes a 100% Web-based payroll and labor distribution module supporting the tax requirements for the federal government, all 50 states and local jurisdictions. The payroll module provides for unlimited deductions, multiple enterprises, centralized and remote check printing and produces batched NACHA Direct Deposit file. It handles shift differentials, restaurant calculations, piece workers and Certified Payrolls for manufacturers and construction industries.

In yet another example, the system includes a web-based accounting module. The web-based accounting module provides for multiple projects to be set up for each client, with each project having unlimited task levels and resources as needed. Approved time charges are posted to Payroll for payment and labor distribution. Client invoices can be generated with just a few mouse clicks. The module may include powerful cash management, accounts receivable and financial reporting features.

The web-based back office accounting module may be seamlessly integrated with payroll and workforce management to support the administrative needs of professional employer organizations (PEO's), staffing agencies, CPA Firms, payroll service bureaus, human resource consulting firms and administrative services organizations (ASO's). With just a few mouse clicks the system generates client invoices, third party checks, consolidated signature ready tax reports, consolidated workers compensation cost reports, and the financial reports needed to manage a business. HR Premier can be interfaced to the general ledger accounting system and provide electronic interface feed to 401K and other third party administrators (TPA)

In an example of a web-time based time clock module, the web-based time clock module is an integrated time and attendance data entry system for employees to “clock in and out” with a click of a mouse or interfaced to a time keypunch system. The integrated time and attendance system is complete with a range of manager access and tools for making necessary adjustments.

In yet another example of a time clock module, reporting available includes: tracking of current and historical logs created by employee punches, audit logs of changes to employee records performed by supervisors, current payroll period status by day, by employee, showing punches, total hours, missing punches, early/late punches, attendance status, etc.

In one example, the system may include an application tracking module, a travel and expense reporting module, and a report publisher module. In one example, the application tracking module provides an integrated employee new hire solution to manage applications, sort, process and hire new employees. In one example, a travel & expense reporting module is a comprehensive expense reporting module that tracks employee expenses, allow for real-time manager approval and expense reporting to the payroll department. In one example, a report publisher module provides an easy to use function to assemble management reports over and beyond any built in standard reports.

In an example of an ad-hoc reporter writer module, end users may securely, easily and quickly select employee information and assemble queries without technical expertise. The queries may be readily exported to Microsoft Excel⁴ for editing or other work for high quality presentations. In one example, the report writer module, besides being a query and reporting tool, may include access to additional tables, enhancement of exporting capabilities and more powerful query manipulation tools. ⁴Excel® is a registered trademark of Microsoft Corporation.

The payroll module, in one example, may have the ability to track work scheduled, work-in-process, and work completed by payroll coordinator, match accounts payable to invoices generated on a client-by-client basis, and forecast the payroll service provider's credit exposure day by day to help identify and prevent cash flow bottlenecks.

Alternative combinations and variations of the examples provided will become apparent based on this disclosure. It is not possible to provide specific examples for all of the many possible combinations and variations of the embodiments described, but such combinations and variations may be claims that eventually issue.

In one example, a payroll and resource management system is used by a plurality of clients, such as companies serviced by a single service bureau, back office provider, payroll processor, or the like. The system comprises a database for storing data and a plurality of modules capable of accessing the database. Each of the plurality of modules is integrated cooperatively in a security management system providing secure activation or deactivation of the modules, such as by entering a password, use of biometric information or a combination of these. Each of the plurality of modules is activatable or deactivatable by the security management system, such that all or only a portion of the modules may be available to a person accessing the system.

For example, the plurality of modules may comprise a time clock module, an invoicing module, and a report writer module, among others. A time clock module includes a system capable of collecting time and attendance data, reviewing time and attendance data, and storing time and attendance data in the database. This may be a computerized punch clock system, allowing an employee to punch in and out or may be a system for tracking work by project/file number and/or record. The invoicing module may include a system capable of generating invoices for back office services, scheduling payments due, and providing an interface for client access to invoices. The report writer module may provide secure access to a portion of the database and/or a query interface for preparing reports based on user defined queries of the database.

In one example, the time clock module collects time and attendance data using a hardware device capable of tracking a position of an employee during the work day. For example, one tracking device is associated with an employee, such that the tracking device is always with the employee. A second tracking device may be located with a file or a record, for example. A time clock module may determine a distance between the first tracking device and the second tracking device. Any collocation of the first tracking device within a threshold distance of the second tracking device may be capable of activating a time recording entry routine on a data entry device, such as a data entry device carried by each employee or a stationary data entry device assigned to the employee. For example, the data entry device may be assigned to be within a threshold distance from the first tracking device and/or the second tracking device. A data entry device may be assigned to one or more employees, and/or an employee may be assigned to more than one entry device. In order to secure access, identifying information may be required to access the date entry device as an employee. For example, a password may be required to gain access to the employee time clock, such as a clock in, clock out toggle or a toggle for starting and stopping a clock for a particular project, file or record. In one example, biometric data is required, such as a fingerprint or retinal scanner. In another example, both biometric data and a password must be entered to gain access to the employee time clock of a particular employee, such as for time entry or editing of the time worked or a description of the work performed.

For example, another example of a module may include a payroll module. The payroll module may process payrolls, providing for calculation of each of the plurality of clients payrolls, secure review of the calculation, and distribution of the payroll based on the calculation and review. The payroll module may include entry of commission fee splits among a plurality of sales agents and secure tracking of commission fees by each of the plurality of sales agents. The payroll module may include secure access by each of the plurality of clients providing each of the plurality of clients access to secure review of the calculation and distribution of the payroll. The payroll module may include secure access by a back office service provider for secure review of the calculation and distribution of the payroll for each of the plurality of clients either individually or in a batch process.

Examples of some additional modules include a project tracking module including secure tracking and review of work scheduled, work in progress, and work completed, and an expense tracking module providing capture of employee business expenses associated with a project tracked by the project tracking module. The expense tracking module may provide an interface for online review, reconciliation and approval by a manager of an appropriate level based on a type of employee business expense, a total amount of the employee business expense, or a combination of both the type and the total amount of the employee business expenses incurred.

In another example of modules, the system may include a forecasting module, such that a payroll service provider's credit exposure is forecast using a comparison of accounts receivables data and invoices generated by the invoice module. The forecasting module may be predictive using historical data stored in the database. For example, historical payments on accounts receivables may be used to determine a probable paid by date, which may be used to predict when a payment will be made. In one example, the system is conservative, using the latest payment date in the database to determine the longest historical delay in payment. Other metrics may be the average or mean payment date associated with historical payments by one or more clients of a back office service provider.

In another example of modules, the system may include a human resource module including human resource reporting and data capture of recruiting information, applicant tracking, labor relations, employee benefits administration, employee compensation, employee education, employee qualifications, and employee terminations. The employment life cycle is captured and human resource reports generated to streamline human resource management. In another example of modules, the system may include a direct deposit module providing secure batch processing of direct deposit of payroll to a plurality of accounts of employees.

1. A payroll and resource management system for use by a plurality of clients, the system comprising:
a database for storing data on data storage media;
a plurality of separate modules capable of accessing the database using a computer processing system, each of the plurality of separate modules being integrated cooperatively in a security management system and each of the plurality of separate modules being activatable or deactivatable by the security management system, the plurality of separate modules comprising:
a time clock module including a system capable of collecting time and attendance data, reviewing time and attendance data, and storing time and attendance data in the database;
an invoicing module including a system capable of generating invoices for back office services, scheduling payments due, and providing an interface for accessing invoices;
a report writer module providing secure access to a portion of the database and a query interface for preparing reports based on user defined queries of the database.

2. The system of claim 1, wherein the time clock module collects time and attendance data using a hardware device capable of tracking a position of an employee during the work day.

3. The system of claim 2, wherein the hardware device includes a first tracking device on the employee.

4. The system of claim 3, wherein a second tracking device is located with a file or a record, and the time clock module determines a distance between the first tracking device and the second tracking device, and collocation of the first tracking device within a threshold distance of the second tracking device activates a time recording entry routine on a data entry device.

5. The system of claim 4, wherein the data entry device is selected to be at least one data entry device located within a second threshold distance from the first tracking device.

6. The system of claim 4, wherein the data entry device is a data entry device assigned to the same employee as the first tracking device.

7. The system of claim 6, wherein the data entry device assigned to the same employee as the first tracking device is assigned to a plurality of employees.

8. The system of claim 6, wherein a plurality of data entry devices are assigned to the employee having the first tracking device, and each of the plurality of data entry devices assigned to the employee having the first tracking device are accessible by the employee having the first tracking device to enter and review time and attendance data.

9. The system of claim 8, wherein each of the plurality of data entry devices are accessible by the employee having the first tracking device are only accessible if the employee having the first tracking device enters a correct password or verifies identity using biometric data.

10. The system of claim 9, wherein verifying identity using biometric data is necessary before the employee having the first tracking device accesses one of the plurality of data entry devices accessible by the employee having the first tracking device.

11. The system of claim 10, wherein the employee having the first tracking device is required to enter a code before the employee having the first tracking device accesses one of the plurality of data entry devices accessible by the employee having the first tracking device.

12. The system of claim 4, wherein the data entry device includes a toggle switch or button capable of being toggled to start and stop recording of time worked on the file or the record associated with the second tracking device.

13. The system of claim 12, wherein the data entry device includes a time data entry system for editing of time data entries associated with the file or the record associated with the second tracking device, such that the employee associated with the first tracking device is capable of entering data relating to the work on the file or the record.

14. The system of claim 13, wherein the time data entry system permits secure editing of the time worked on the file or the record.

15. The system of claim 1, wherein the report writer module includes an interface for exporting reports to a word processing program, an email program, a spreadsheet program, a presentation program, or a combination thereof.

16. The system of claim 15, wherein the interface for exporting reports exports reports to a word processing program, an email program, and a presentation manager program.

17. The system of claim 1, wherein the plurality of modules further comprises:
a payroll module providing for calculation of each of the plurality of clients payrolls, secure review of the calculation, and distribution of the payroll based on the calculation and review.

18. The system of claim 17, wherein the payroll module includes entry of commission fee splits among a plurality of sales agents and secure tracking of commission fees by each of the plurality of sales agents.

19. The system of claim 17, wherein the payroll module includes secure access by each of the plurality of clients, each of the plurality of clients having access to secure review of the calculation and distribution of the payroll.

20. The system of claim 19, wherein the payroll module includes secure access by a back office service provider for secure review of the calculation and distribution of the payroll for each of the plurality of clients either individually or in a batch process.

21. The system of claim 1, wherein the plurality of separate modules further comprises:
a project tracking module including secure tracking and review of work scheduled, work in progress, and work completed; and
an expense tracking module providing capture of employee business expenses associated with a project tracked by the project tracking module, the expense tracking module allowing online review, reconciliation and approval by a manager of an appropriate level based on a type of employee business expense, a total amount of the employee business expense, or a combination of both the type and the total amount of the employee business expenses incurred.

22. The system of claim 1, wherein the system includes a forecasting module, such that a payroll service provider's credit exposure is forecast using a comparison of accounts receivables data and invoices generated by the invoice module.

23. The system of claim 22, wherein the forecasting module is predictive using historical data stored in the database.

24. The system of claim 1, wherein the plurality of separate modules further comprises:
a human resource module including human resource reporting and data capture of recruiting information, applicant tracking, labor relations, employee benefits administration, employee compensation, employee education, employee qualifications, and employee terminations, such that the employment life cycle is captured and human resource reports generated.

25. The system of claim 1, wherein the plurality of separate modules further comprises:
a direct deposit module providing secure batch processing of direct deposit of payroll to a plurality of accounts of employees.
